(19) United States
(12) Patent Application Publication
(10) Pub. No.: US 2021/0009155 A1
(43) Pub. Date: Jan. 14, 2021

(54) UNMANNED VEHICLE CONTROL SYSTEM, UNMANNED VEHICLE, AND UNMANNED VEHICLE CONTROL METHOD

(71) Applicant: Komatsu Ltd., Tokyo (JP)

(72) Inventors: Ryuu Yamamura, Tokyo (JP); Akiharu Nishijima, Tokyo (JP)

(73) Assignee: Komatsu Ltd., Tokyo (JP)

(21) Appl. No.: 16/980,646

(22) PCT Filed: Feb. 20, 2019
(86) PCT No.: PCT/JP2019/006361

§ 371 Date: Sep. 14, 2020

(30) Foreign Application Priority Data
Jul. 31, 2018 (JP) 2018-144449

(51) Int. Cl. B60W 60/00; B60W 30/14; G01C 21/34

(52) U.S. Cl. CPC B60W 60/001; G01C 21/3407; B60W 30/143

(57) ABSTRACT

An unmanned vehicle control system includes: a travel condition data acquisition unit that acquires travel condition data specifying a travel condition of an unmanned vehicle, the travel condition data including a target travel speed and a target azimuth of the unmanned vehicle at each of a plurality of travel points; a travel condition change unit that outputs a change command to change the travel condition specified by the travel condition data based on a difference in the target azimuth among the plurality of travel points; and a travel control unit that outputs a control command to control traveling of the unmanned vehicle based on the change command.

### FIELD

The present invention relates to an unmanned vehicle control system, an unmanned vehicle, and an unmanned vehicle control method.

### BACKGROUND

In a work site in a wide area such as a mine, an unmanned vehicle that travels in an unmanned state is sometimes used.

### CITATION LIST

### Patent Literature

Patent Literature 1: JP 2010-073080 A

### SUMMARY

### Technical Problem

An unmanned vehicle travels on a work site based on travel condition data transmitted from a control facility. The unmanned vehicle travels according to a target travel course specified by the travel condition data.

It is preferable that the unmanned vehicle travel at a high speed in order to suppress a decrease in productivity at the work site. On the other hand, the unmanned vehicle is likely to deviate from the target travel course depending on travel conditions. If the unmanned vehicle deviates from the target travel course and the operation of the unmanned vehicle is stopped, the productivity at the work site is likely to decrease.

An aspect of the present invention aims to suppress a decrease in productivity while ensuring safety at a work site where an unmanned vehicle operates.

### Solution to Problem

According to an aspect of the present invention, an unmanned vehicle control system comprises: a travel condition data acquisition unit that acquires travel condition data specifying a travel condition of an unmanned vehicle, the travel condition data including a target travel speed and a target azimuth of the unmanned vehicle at each of a plurality of travel points; a travel condition change unit that outputs a change command to change the travel condition specified by the travel condition data based on a difference in the target azimuth among the plurality of travel points; and a travel control unit that outputs a control command to control traveling of the unmanned vehicle based on the change command.

### Advantageous Effects of Invention

According to an aspect of the present invention, it is possible to suppress the decrease in productivity while ensuring the safety at the work site where the unmanned vehicle operates.

### BRIEF DESCRIPTION OF DRAWINGS

FIG. 1 is a view schematically illustrating examples of a management system and an unmanned vehicle according to an embodiment.

FIG. 2 is a view schematically illustrating the unmanned vehicle and a travel path according to the embodiment.

FIG. 3 is a functional block diagram illustrating an unmanned vehicle control system according to the embodiment.

FIG. 4 is a schematic view for describing a travel condition of the unmanned vehicle according to the embodiment.

FIG. 5 is a schematic view for describing the travel condition of the unmanned vehicle according to the embodiment.

FIG. 6 is a schematic view for describing a threshold according to the embodiment.

FIG. 7 is a flowchart illustrating an unmanned vehicle control method according to the embodiment.

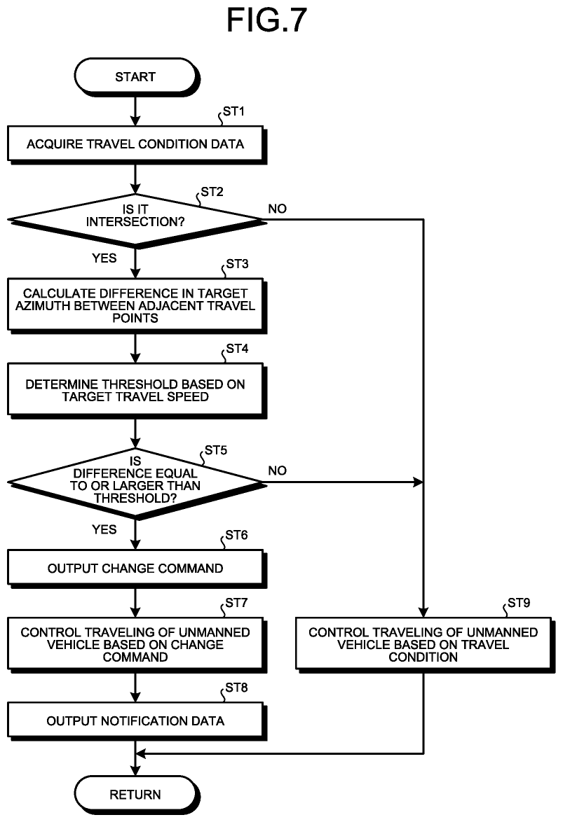

FIG. 8 is a block diagram illustrating an example of a computer system according to the embodiment.

### DESCRIPTION OF EMBODIMENTS

Hereinafter, embodiments of the present invention will be described with reference to the drawings, but the present invention is not limited thereto. Components of the embodiments to be described below can be combined as appropriate. In addition, there is also a case where some components are not used.

[Management System]

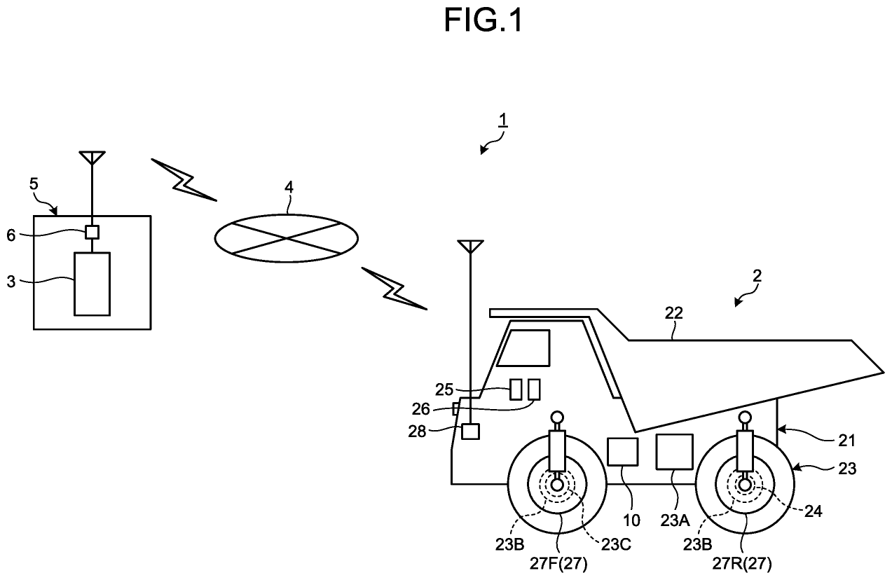

FIG. 1 is a view schematically illustrating examples of a management system 1 and an unmanned vehicle 2 according to the present embodiment. The unmanned vehicle 2 refers to a work vehicle that travels in an unmanned state based on a control command without depending on a driving operation performed by a driver.

The unmanned vehicle 2 operates at a work site. In the present embodiment, the work site is a mine or a quarry. The unmanned vehicle 2 is a dump truck that travels at the work site and transports a cargo. The mine refers to a place or a business site where a mineral is mined. The quarry refers to a place or a business site where a rock is mined. As the cargo transported to the unmanned vehicle 2, ore or dirt excavated in the mine or the quarry is exemplified.

The management system 1 includes a management device 3 and a communication system 4. The management device 3 includes a computer system and is installed in a control facility 5 at the work site. A controller exists in the control facility 5. The communication system 4 performs communication between the management device 3 and the unmanned vehicle 2. The management device 3 is connected with a wireless communication device 6. The communication system 4 includes the wireless communication device 6. The management device 3 and the unmanned vehicle 2 wirelessly communicate with each other via the communication system 4. The unmanned vehicle 2 travels on a travel path HL at the work site based on travel condition data transmitted from the management device 3.

[Unmanned Vehicle]

The unmanned vehicle 2 includes a vehicle main body 21, a dump body 22 supported by the vehicle main body 21, a traveling device 23 that supports the vehicle main body 21, a speed sensor 24, an azimuth sensor 25, a position sensor 26, a wireless communication device 28, and a control device 10.

The vehicle main body 21 includes a vehicle body frame and supports the dump body 22. The dump body 22 is a member on which a cargo is loaded.

The traveling device 23 includes wheels 27 and travels on the travel path HL. The wheels 27 include front wheels 27F and rear wheels 27R. Tires are mounted on the wheels 27. The traveling device 23 has a drive device 23A, a brake device 23B, and a steering device 23C.

The drive device 23A generates a driving force for accelerating the unmanned vehicle 2. The drive device 23A includes an internal combustion engine such as a diesel engine. Note that the drive device 23A may include an electric motor. The driving force generated by the drive device 23A is transmitted to the rear wheel 27R so that the rear wheels 27R rotate. The unmanned vehicle 2 travels autonomously as the rear wheels 27R rotate. The brake device 23B generates a braking force for decelerating or stopping the unmanned vehicle 2. The steering device 23C can adjust a traveling direction of the unmanned vehicle 2. The traveling direction of the unmanned vehicle 2 includes an azimuth of the front part of the vehicle main body 21. The steering device 23C adjusts the traveling direction of the unmanned vehicle 2 by steering the front wheels 27F.

The speed sensor 24 detects a travel speed of the unmanned vehicle 2. Detection data of the speed sensor 24 includes travel speed data indicating the travel speed of the traveling device 23.

The azimuth sensor 25 detects an azimuth of the unmanned vehicle 2. Detection data of the azimuth sensor 25 includes azimuth data indicating the azimuth of the unmanned vehicle 2. The azimuth of the unmanned vehicle 2 is a traveling direction of the unmanned vehicle 2. The azimuth sensor 25 includes a gyro sensor, for example.

The position sensor 26 detects a position of the unmanned vehicle 2 traveling on the travel path HL. Detection data of the position sensor 26 includes absolute position data indicating an absolute position of the unmanned vehicle 2. The absolute position of the unmanned vehicle 2 is detected using a global navigation satellite system (GNSS). The global navigation satellite system includes a global positioning system (GPS). The position sensor 26 includes a GPS receiver. The global navigation satellite system detects the absolute position of the unmanned vehicle 2 specified by coordinate data of the longitude, latitude, and altitude. The absolute position of the unmanned vehicle 2 specified in a global coordinate system is detected by the global navigation satellite system. The global coordinate system is a coordinate system fixed to the earth.

The wireless communication device 28 wirelessly communicates with the wireless communication device 6 connected to the management device 3. The communication system 4 includes the wireless communication device 28.

The control device 10 includes a computer system and is arranged in the vehicle main body 21. The control device 10 outputs control commands to control traveling of the traveling device 23 of the unmanned vehicle 2. The control commands output from the control device 10 include an accelerator command to operate the drive device 23A, a brake command to operate the brake device 23B and a steering command to operate the steering device 23C. The drive device 23A generates a driving force for accelerating the unmanned vehicle 2 based on the accelerator command output from the control device 10. The brake device 23B generates a braking force for decelerating or stopping the unmanned vehicle 2 based on the brake command output from the control device 10. The steering device 23C generates a swinging force for changing a direction of the front wheels 27F so as to make the unmanned vehicle 2 travel straight or swing based on the steering command output from the control device 10.

[Travel Path]

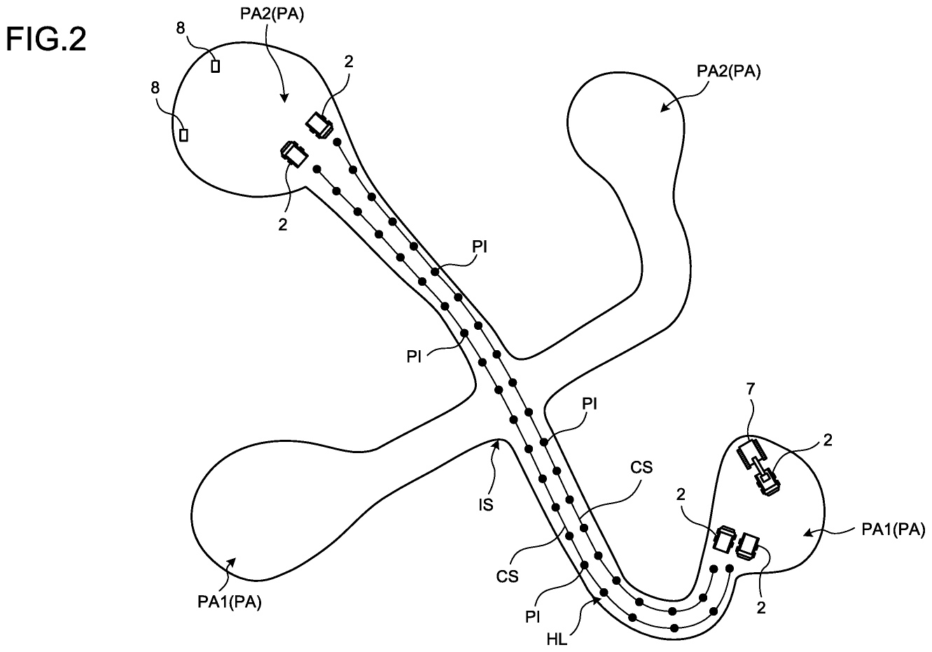

FIG. 2 is a view schematically illustrating the unmanned vehicle 2 and the travel path HL according to the present embodiment. The travel path HL leads to a plurality of work sites PA in the mine. The work sites PA include at least one of a loading site PA1 and a discharging site PA2. An intersection IS is provided on the travel path HL.

The loading site PA1 refers to an area where loading work for loading the cargo on the unmanned vehicle 2 is performed. At the loading site PA1, a loader 7 such as a hydraulic excavator operates. The discharging site PA2 refers to an area where discharging work for discharging the cargo from the unmanned vehicle 2 is performed. For example, a crusher 8 is provided at the discharging site PA2.

The management device 3 sets a travel condition of the unmanned vehicle 2 on the travel path HL. The unmanned vehicle 2 travels on the travel path HL based on travel condition data that specifies the travel condition transmitted from the management device 3.

The travel condition data that specifies the travel condition of the unmanned vehicle 2 includes target position x and y, a target travel speed Vr, a target azimuth θ, and a target travel course CS of the unmanned vehicle 2.

As illustrated in FIG. 2, the travel condition data includes a plurality of travel points PI set on the travel path HL at intervals. The interval between the travel points PI is set to, for example, 1 [m]. Note that the interval between the travel points PI may be set in the range between 1 [m] and 5 [m]. The travel point PI specifies the target positions x and y of the unmanned vehicle 2.

The target travel speed Vr and the target azimuth θ are set for each of the plurality of travel points PI. The target travel course CS is specified by a line connecting the plurality of travel points PI.

That is, the travel condition data that specifies the travel condition of the unmanned vehicle 2 includes the plurality of travel points PI indicating the target positions x and y of the unmanned vehicle 2, and the target travel speed Vr and the target azimuth θ of the unmanned vehicle 2 at each of the plurality of travel points PI.

The target positions x and y of the unmanned vehicle 2 refers to target positions of the unmanned vehicle 2 specified in the global coordinate system. That is, the target positions x and y refer to the target positions in the coordinate data specified by the longitude, latitude and altitude. The target position x refers to a target position in longitude (x-coordinate). The target position y refers to a target position in latitude (y-coordinate). Note that the target positions x and y of the unmanned vehicle 2 may be specified in a local coordinate system of the unmanned vehicle 2.

The target travel speed Vr of the unmanned vehicle 2 refers to a target travel speed of the unmanned vehicle 2 at the time of traveling at (passing through) the travel point PI. When the target travel speed Vr at a first travel point PI is set to a first target travel speed Vr1, the drive device 23A or the brake device 23B of the unmanned vehicle 2 is controlled such that an actual travel speed Vs of the unmanned vehicle 2 at the time of traveling on the first travel point PI is the first target travel speed Vr1. When the target travel speed Vr at a second travel point PI is set to a second target travel speed Vr2, the drive device 23A or the brake device 23B of the unmanned vehicle 2 is controlled such that the actual travel speed Vs of the unmanned vehicle 2 at the time of traveling on the second travel point PI is the second target travel speed Vr2.

The target azimuth θ of the unmanned vehicle 2 refers to a target azimuth of the unmanned vehicle 2 at the time of traveling at (passing through) the travel point PI. In addition, the target azimuth θ refers to an azimuth angle of the unmanned vehicle 2 with respect to the reference azimuth (for example, north). In other words, the target azimuth θ is a target azimuth of the front part of the vehicle main body 21, and indicates a target traveling direction of the unmanned vehicle 2. When the target azimuth θ at the first travel point PI is set to a first target azimuth θ1, the steering device 23C of the unmanned vehicle 2 is controlled such that an actual azimuth θs of the unmanned vehicle 2 at the time of traveling on the first travel point PI is the first target azimuth θ1. When the target azimuth θ at the second travel point PI is set to a second target azimuth θ2, the steering device 23C of the unmanned vehicle 2 is controlled such that the actual azimuth θs of the unmanned vehicle 2 at the time of traveling on the second travel point PI is the second target azimuth θ2.

[Control System]

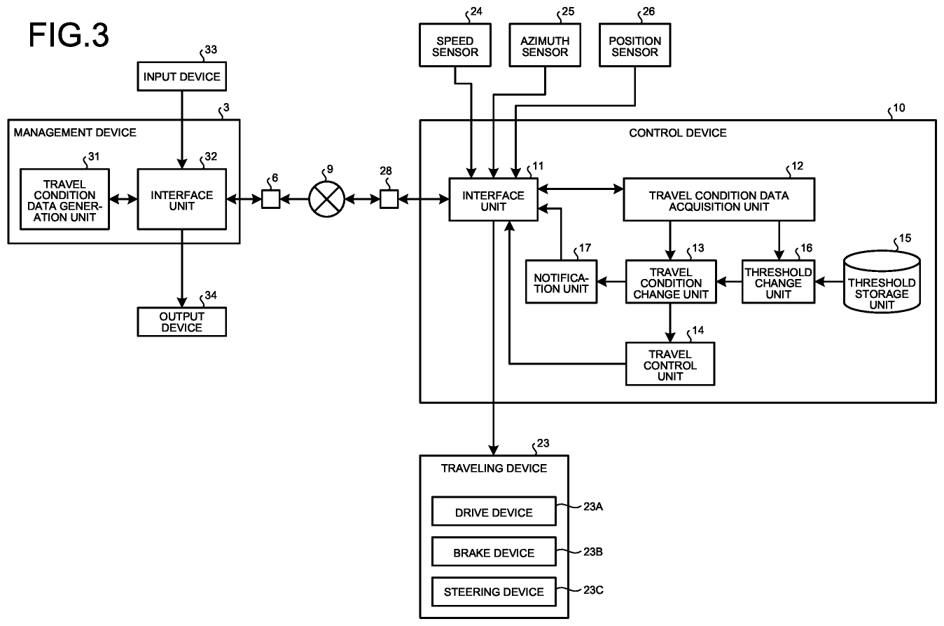

FIG. 3 is a functional block diagram illustrating a control system of the unmanned vehicle 2 according to the present embodiment. The control system includes the control device 10 and the management device 3. The control device 10 can communicate with the management device 3 via the communication system 4.

The management device 3 includes a travel condition data generation unit 31 and an interface unit 32. The travel condition data generation unit 31 generates travel condition data that specifies a travel condition of the unmanned vehicle 2. The interface unit 32 is connected to each of an input device 33, an output device 34, and the wireless communication device 6. The input device 33, the output device 34, and the wireless communication device 6 are installed in the control facility 5. The travel condition data generation unit 31 communicates with each of the input device 33, the output device 34, and the wireless communication device 6 via the interface unit 32.

The input device 33 is operated by the controller of the control facility 5 to generate input data. The input data generated by the input device 33 is output to the management device 3. The management device 3 acquires the input data from the input device 33. As the input device 33, a contact-type input device that is operated by the controller's hand, such as a computer keyboard, a mouse, a touch panel, an operation switch, and an operation button, is exemplified. Note that the input device 33 may be a voice input device operated by the controller's voice.

The output device 34 provides output data to the controller of the control facility 5. The output device 34 may be a display device that outputs display data, a printing device that outputs print data, or a voice output device that outputs voice data. As the display device, a flat panel display, such as a liquid crystal display (LCD) and an organic electroluminescence display (OELD), is exemplified.

The travel condition is determined by, for example, the controller existing in the control facility 5. The controller operates the input device 33 connected to the management device 3. The travel condition data generation unit 31 generates the travel condition data based on the input data generated by operating the input device 33. The interface unit 32 transmits the travel condition data to the unmanned vehicle 2 via the communication system 4. The control device 10 of the unmanned vehicle 2 acquires the travel condition data transmitted from the management device 3 via the communication system 4.

The control device 10 includes an interface unit 11, a travel condition data acquisition unit 12, a travel condition change unit 13, a travel control unit 14, a threshold storage unit 15, a threshold change unit 16, and a notification unit 17.

The interface unit 11 is connected to each of the speed sensor 24, the azimuth sensor 25, the position sensor 26, the traveling device 23, and the wireless communication device 28. The interface unit 11 communicates with each of the speed sensor 24, the azimuth sensor 25, the position sensor 26, the traveling device 23, and the wireless communication device 28.

The travel condition data acquisition unit 12 acquires the travel condition data transmitted from the management device 3 via the interface unit 11.

The travel condition change unit 13 outputs a change command to change the travel condition specified by the travel condition data based on a difference Δθ in the target azimuth θ between adjacent travel points PI specified in the travel condition data. The travel condition data that specifies the travel condition of the unmanned vehicle 2 includes the target azimuth θ of the unmanned vehicle 2 at each of the plurality of travel points PI. The travel condition change unit 13 calculates the difference Δθ in the target azimuths 0 between the adjacent travel points PI based on the travel condition data acquired by the travel condition data acquisition unit 12. The travel condition change unit 13 outputs the change command to change the travel condition specified by the travel condition data based on the calculated difference Δθ in the target azimuth θ.

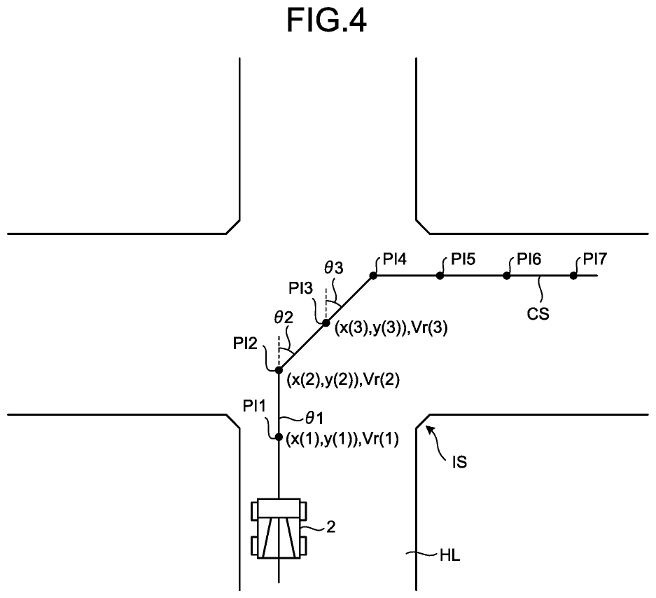

FIG. 4 is a schematic view for describing the travel condition of the unmanned vehicle 2 according to the present embodiment, and is the view schematically illustrating a plurality of travel points PI set at the intersection IS of the travel path HL. FIG. 4 illustrates an example in which the target travel course CS is set such that the unmanned vehicle 2 turns right at the intersection IS.

In the example illustrated in FIG. 4, the plurality of travel points PI (PI(1), PI(2), PI(3), . . . , and PI(i)) are specified at the intersection IS. The target positions x and y, the target travel speed Vr, and the target azimuth θ are set for each of the plurality of travel points PI.

Target positions x(1) and y(1), a target travel speed Vr(1), and a target azimuth θ(1) are set at the travel point PI(1). Target positions x(2) and y(2), a target travel speed Vr(2), and a target azimuth θ(2) are set at the travel point PI(2). Similarly, target positions x(3) and y(3), a target travel speed Vr(3), and a target azimuth θ(3) are set at the travel point PI(3). Target positions x(i) and y(i), a target travel speed Vr(i), and a target azimuth θ(i) are set at the travel point PI(i).

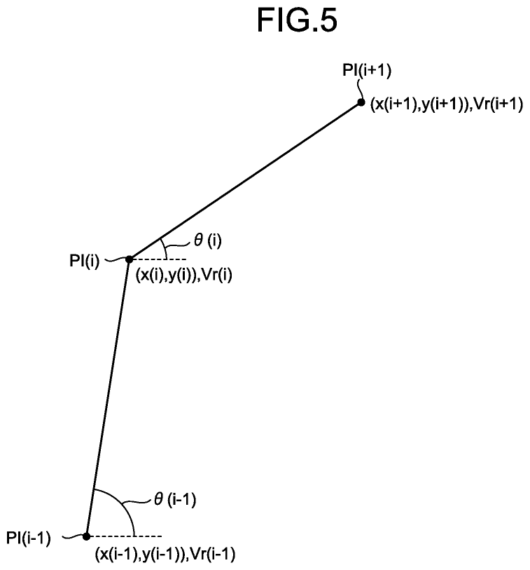

FIG. 5 is a schematic view for describing the travel condition of the unmanned vehicle 2 according to the present embodiment, and is the view obtained by extracting some travel points PI. The travel point PI(i) and the travel point PI(i−1) are adjacent to each other. In the example illustrated in FIG. 5, the travel condition change unit 13 calculates a difference Δθ(i) between the target azimuth θ(i) of the travel point PI(i) and the target azimuth θ(i−1) of the travel point PI(i−1). The difference Δθ(i) is calculated by calculation [θ(i)−θ(i−1)].

In the example illustrated in FIG. 4, the travel point PI(2) and the travel point PI(1) are adjacent to each other. A difference Δθ(2) between the target azimuth θ(2) of the travel point PI(2) and the target azimuth θ(1) of the travel point PI(1) is calculated by calculation [θ(2)−θ(1)]. The travel point PI(3) and the travel point PI(2) are adjacent to each other. A difference Δθ(3) between the target azimuth θ(3) of the travel point PI(3) and the target azimuth θ(2) of the travel point PI(2) is calculated by calculation [θ(3)−θ(2)]. In the example illustrated in FIG. 4, the difference Δθ(2) is larger than the difference Δθ(3).

Note that the travel condition data generation unit 31 does not necessarily set the target azimuth θ at the travel point PI. When the travel condition data that specifies the travel point PI at which the target azimuth θ has not been set is transmitted from the management device 3 to the control device 10, the travel condition change unit 13 can calculate the target azimuth θ based on the target positions x and y at the travel point PI. For example, when a distance of the x-coordinate between the travel point PI(i) and the travel point PI(i−1), which are adjacent, is dx(i) and a distance of the y-coordinate between the travel point PI(i) and the travel point PI(i−1), which are adjacent, is dy(i), dx(i) and dy(i) are expressed by the following Formulas (1) and (2).

dx(i)=x(i)−x(i−1) (1)

dy(i)=y(i)−y(i−1) (2)

The target azimuth θ(i) is represented by the arc tangent of a difference between dx(i) and dy(i). That is, the target azimuth θ(i) is expressed by the following Formula (3).

θ(i)=arc tan[dy(i)/dx(i)] (3)

The travel condition change unit 13 calculates the difference Δθ in the target azimuth θ between the adjacent travel points PI, and then, outputs the change command when determining that the difference Δθ is equal to or larger than a threshold Sθ. The threshold Sθ is a threshold related to the difference Δθ in the target azimuth θ, is a predetermined value, and is stored in the threshold storage unit 15. The travel condition change unit 13 compares the difference Δθ with the threshold Sθ, and outputs the change command to change the travel condition specified by the travel condition data when determining that the difference Δθ is equal to or larger than the threshold Sθ.

The change command includes lowering the actual travel speed Vs of the unmanned vehicle 2 below the target travel speed Vr. For example, in the example illustrated in FIG. 4, when the difference Δθ(2) between the target azimuth θ(2) of the travel point PI(2) and the target azimuth θ(1) of the travel point PI(1) is equal to or larger than the threshold Sθ, the travel condition change unit 13 outputs the change command such that the actual travel speed Vs when the unmanned vehicle 2 travels at the travel point PI(2) is lower than the target travel speed Vr(2) set at the travel point PI(2).

The travel control unit 14 outputs the control command to control the traveling of the unmanned vehicle 2 to the traveling device 23 based on the change command output from the travel condition change unit 13. For example, in a case where the change command is output such that the actual travel speed Vs when the unmanned vehicle 2 travels at the travel point PI(2) is lower than the target travel speed Vr(2) set at the travel point PI(2), the travel control unit 14 outputs the control command to the traveling device 23 such that the unmanned vehicle 2 travels at the travel speed Vs lower than the target travel speed Vr(2), instead of the target travel speed Vr(2), when traveling at the travel point PI(2).

Note that the change command may include setting the actual travel speed Vs of the unmanned vehicle 2 to zero. In the example illustrated in FIG. 4, when the difference Δθ(2) between the target azimuth θ(2) of the travel point PI(2) and the target azimuth θ(1) of the travel point PI(1) is equal to or larger than the threshold Sθ, the travel condition change unit 13 may output the change command such that the unmanned vehicle 2 stops at the travel point PI(2). The travel control unit 14 may output the control command to the traveling device 23 based on the change command output from the travel condition change unit 13 such that the unmanned vehicle 2 stops when the unmanned vehicle 2 travels at the travel point PI(2).

In addition, the travel control unit 14 also controls the traveling device 23 such that the unmanned vehicle 2 travels according to the target travel course CS. In the present embodiment, the travel control unit 14 controls traveling of the unmanned vehicle 2 based on dead reckoning navigation. The dead reckoning navigation refers to navigation in which traveling is performed while estimating a current position of the unmanned vehicle 2 based on a moving distance and an azimuth (azimuth change amount) of the unmanned vehicle 2 from a starting point whose longitude and latitude are known. The moving distance of the unmanned vehicle 2 is detected by the speed sensor 24. The azimuth of the unmanned vehicle 2 is detected by the azimuth sensor 25. The travel control unit 14 acquires the detection data of the speed sensor 24 and the detection data of the azimuth sensor 25 to calculate the moving distance and the azimuth change amount of the unmanned vehicle (2) from the known starting point, and controls the traveling device (23) while estimating the current position of the unmanned vehicle (2). In the following description, the current position of the unmanned vehicle 2, which is estimated based on the detection data of the speed sensor 24 and the detection data of the azimuth sensor 25, is appropriately referred to as an estimated position.

In the dead reckoning navigation, the travel control unit 14 calculates the estimated position of the unmanned vehicle 2 based on the detection data of the speed sensor 24 and the detection data of the azimuth sensor 25 to control the traveling device 23 such that the unmanned vehicle 2 travels according to the target travel course CS. In the dead reckoning navigation, an error is likely to occur between the estimated position and an actual position of the unmanned vehicle 2 due to accumulation of detection errors of one or both of the speed sensor 24 and the azimuth sensor 25 if a traveling distance of the unmanned vehicle 2 becomes long. As a result, the unmanned vehicle 2 may deviate from the target travel course CS.

In the present embodiment, the travel control unit 14 corrects the estimated position of the unmanned vehicle 2 traveling by the dead reckoning navigation based on the detection data of the position sensor 26. That is, the travel control unit 14 causes the unmanned vehicle 2 to travel while correcting the estimated position of the unmanned vehicle 2 traveling by the dead reckoning navigation using a detected position (absolute position) of the unmanned vehicle 2 detected by the position sensor 26.

The travel condition change unit 13 does not output the change command when determining that the difference Δθ in the target azimuth θ is smaller than the threshold Sθ. When the difference Δθ in the target azimuth θ is smaller than the threshold θS, the travel control unit 14 outputs the control command to the traveling device 23 such that the unmanned vehicle 2 travels based on the travel condition specified by the travel condition data.

For example, when the difference Δθ(2) between the target azimuth θ(3) of the travel point PI(3) and the target azimuth θ(2) of the travel point PI(2) is smaller than the threshold Sθ in the example illustrated in FIG. 4, the travel condition change unit 13 does not output the change command. When the unmanned vehicle 2 travels at the travel point PI(3), the travel control unit 14 outputs the control command such that the vehicle travels at the target travel speed Vr(3) set at the travel point PI(3).

The threshold change unit 16 changes the threshold Sθ based on the target travel speed Vr set at the travel point PI. The threshold change unit 16 decreases the threshold Sθ as the target travel speed Vr set at the travel point PI increases. The travel condition change unit 13 outputs the change command based on the threshold Sθ determined by the threshold change unit 16.

In the present embodiment, the threshold change unit 16 changes the threshold Sθ based on an expression illustrated in Formula (4). In Formula (4), Vr is the target travel speed set at the travel point PI. Ro is a minimum turning radius of the unmanned vehicle 2. α is a constant.

Sθ=arc tan(1/Ro)+α×arc tan(1/Vr) (4)

Note that the threshold storage unit 15 may store table data indicating the relationship between the target travel speed Vr and the threshold Sθ. The threshold change unit 16 may change the threshold Sθ based on the target travel speed Vr derived from the travel condition data and the table data stored in the threshold storage unit 15.

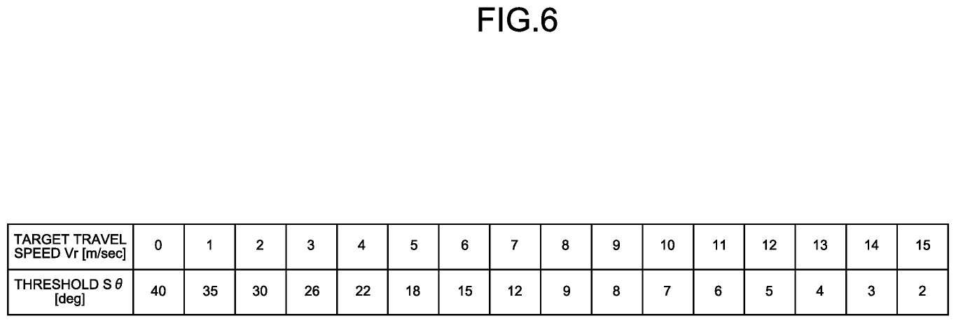

FIG. 6 is a schematic view for describing the threshold Sθ according to the present embodiment. As illustrated in FIG. 6, the table data indicating the relationship between the target travel speed Vr and the threshold Sθ may be set and stored in the threshold storage unit 15. As illustrated in FIG. 6, the threshold Sθ is set to a smaller value as the target travel speed Vr set at the travel point PI is higher.

When the change command is output from the travel condition change unit 13, the notification unit 17 outputs notification data indicating that the change command has been output. The notification data output from the notification unit 17 is transmitted to the management device 3 via the communication system 4. The notification data may include display data to be displayed on a display device connected to the management device 3 and voice data to be output from a voice output device connected to the management device 3. That is, the display data indicating that the change command has been output may be displayed on the display device of the control facility 5, and the voice data indicating that the change command has been output may be output from the voice output device of the control facility 5.

[Control Method]

Next, a method for controlling the unmanned vehicle 2 according to the present embodiment will be described. FIG.

7 is a flowchart illustrating a method for controlling the unmanned vehicle 2 according to this embodiment.

Travel condition data is transmitted from the management device 3 to the control device 10. The travel condition data acquisition unit 12 acquires the travel condition data transmitted from the management device 3 (Step ST1).

The travel control unit 14 outputs a control command to control the traveling device 23 such that the unmanned vehicle 2 travels according to a travel condition specified by the travel condition data.

The travel condition change unit 13 determines whether the unmanned vehicle 2 traveling according to the travel condition is traveling at the intersection IS (Step ST2).

The travel condition change unit 13 can determine whether the unmanned vehicle 2 traveling according to the travel condition is traveling at the intersection IS, for example, based on the target positions x and y set at the travel point PI. Note that the travel condition data generation unit 31 may add intersection data indicating that the intersection IS specified to the travel point PI. The travel condition change unit 13 may determine whether the unmanned vehicle 2 traveling according to the travel condition is traveling at the intersection IS based on the intersection data.

If determining that the unmanned vehicle 2 is traveling at the intersection IS in Step ST2 (Step ST2: Yes), the travel condition change unit 13 calculates the difference Δθ in the target azimuth θ between the adjacent travel points PI at the intersection IS (Step ST3).

The threshold change unit 16 determines the threshold Sθ based on the target travel speed Vr set at the travel point PI (Step ST4).

The travel condition change unit 13 determines whether the difference Δθ in the target azimuth θ calculated in Step ST3 is equal to or larger than the threshold Sθ determined in Step ST4 (Step ST5).

If determining that the difference Δθ is equal to or larger than the threshold Sθ in Step ST5 (Step ST5: Yes), the travel condition change unit 13 outputs a change command to change the travel condition specified by the travel condition data (Step ST6).

The change command includes lowering the travel speed Vs of the unmanned vehicle 2 below the target travel speed Vr. In the present embodiment, the change command includes setting the travel speed Vs of the unmanned vehicle 2 to zero. The travel condition change unit 13 outputs the change command to set the target travel speed Vr of the unmanned vehicle 2, which passes through the travel point PI determined to have the difference Δθ equal to or larger than the threshold Sθ, to zero.

The travel control unit 14 outputs a control command to control traveling of the unmanned vehicle 2 based on the change command output from the travel condition change unit 13 (Step ST7).

That is, the travel control unit 14 controls the traveling of the unmanned vehicle 2 based on the travel condition changed by the change command. In the present embodiment, the travel control unit 14 outputs the control command such that the unmanned vehicle 2 stops at the travel point PI where the target travel speed Vr is set to zero. As a result, the unmanned vehicle 2 stops at the intersection IS. The unmanned vehicle 2 can be stopped on the target travel course CS without deviating from the target travel course CS.

For example, when the difference Δθ(2) between the target azimuth θ(2) of the travel point PI(2) and the target azimuth θ(1) of the travel point PI(1) is equal to or larger than the threshold Sθ in the example illustrated in FIG. 4, the unmanned vehicle 2 stops at the travel point PI(2).

The notification unit 17 outputs notification data indicating that the change command has been output from the travel condition change unit 13 (Step ST8).

The notification data output from the notification unit 17 is transmitted to the management device 3 via the communication system 4. The management device 3 causes the output device 34 to output the notification data. The controller existing in the control facility 5 can recognize that the unmanned vehicle 2 has stopped at the intersection IS based on the notification data output from the output device 34.

The controller operates the input device 33 to recreate travel condition data. The travel condition data generation unit 31 recreates the travel condition data such that the target travel speed Vr set at the travel point PI of the intersection IS becomes low, for example. The controller recreates the travel condition data such that the target travel course CS draws a gentle curve. The regenerated travel condition data is transmitted to the control device 10 of the unmanned vehicle 2 via the communication system 4. The travel control unit 14 of the control device 10 restarts traveling of the unmanned vehicle 2 based on the transmitted travel condition data. Since the unmanned vehicle 2 does not deviate from the target travel course CS, the traveling can be restarted at an early stage.

If determining that the unmanned vehicle 2 is not traveling at the intersection IS in Step ST2 (Step ST2: No) and if determining that the difference Δθ is smaller than the threshold Sθ in Step ST5 (Step ST5: No), the travel control unit 14 outputs the control command to control the traveling of the unmanned vehicle 2 such that the unmanned vehicle 2 travels according to the travel condition specified by the travel condition data acquired by the travel condition data acquisition unit 12 (Step ST9).

[Computer System]

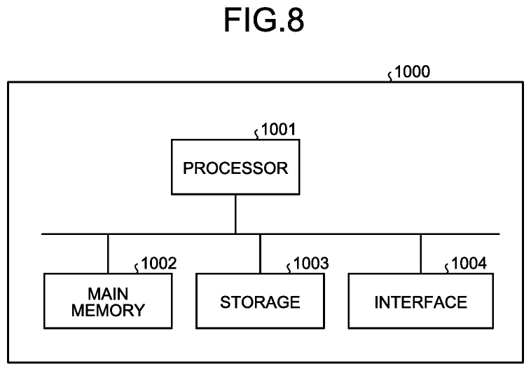

FIG. 8 is a block diagram illustrating an example of a computer system 1000. Each of the management device 3 and the control device 10 described above includes the computer system 1000. The computer system 1000 includes: a processor 1001 such as a central processing unit (CPU); a main memory 1002 including a nonvolatile memory such as a read only memory (ROM) and a volatile memory such as a random access memory (RAM); a storage 1003; and an interface 1004 including an input/output circuit. The functions of the management device 3 and the functions of the control device 10 described above are stored in the storage 1003 as programs. The processor 1001 reads the program from the storage 1003, expands the read program in the main memory 1002, and executes the above-described processing according to the program. Note that the program may be delivered to the computer system 1000 via a network.

[Effect]

As described above, the difference Δθ in the target azimuth θ between the adjacent travel points PI is calculated when the unmanned vehicle 2 travels at the intersection IS in the case where the travel condition data is transmitted from the control facility 5 to the unmanned vehicle 2 according to the present embodiment. When the difference Δθ in the target azimuth θ is equal to or larger than the threshold Sθ, the change command to change the travel condition is output such that the travel speed Vs of the unmanned vehicle 2 becomes lower than the target travel speed Vr, and thus, the unmanned vehicle 2 is prevented from deviating from the target travel course CS. Therefore, a decrease in productivity at the work site is suppressed.

The difference Δθ represents the turning radius of the unmanned vehicle 2 when turning at the intersection IS or turning a curve of the travel path HL. The large difference Δθ represents that the turning radius of the unmanned vehicle 2 is small. That is, the large difference Δθ represents that the unmanned vehicle 2 turns a steep curve. If the target travel speed Vr set at the travel point PI is high in the case where the difference Δθ is large, the unmanned vehicle 2 travels at a high speed on a steep curve. If the target travel speed Vr is high despite the large difference Δθ, the unmanned vehicle 2 is highly likely to deviate from the target travel course CS. If the unmanned vehicle 2 deviates from the target travel course CS and the operation of the unmanned vehicle 2 is stopped, the productivity at the work site is likely to decrease.

In the present embodiment, when it is determined that the unmanned vehicle 2 is highly likely to deviate from the target travel course CS based on the difference Δθ in the target azimuth θ, the travel condition specified by the travel condition data is changed such that the unmanned vehicle 2 does not deviate from the target travel course CS. The unmanned vehicle 2 travels according to the travel condition after being changed based on the change command, and thus, is prevented from deviating from the target travel course CS.

In the present embodiment, the difference Δθ in the target azimuth θ and the threshold Sθ are compared, and the travel condition specified by the travel condition data is changed when the difference Δθ is equal to or larger than the threshold Sθ. On the other hand, when the difference Δθ in the target azimuth θ is smaller than the threshold Sθ, the travel condition specified by the travel condition data is not changed, and the unmanned vehicle 2 travels based on the travel condition generated by the management device 3. When the difference Δθ in the target azimuth θ is smaller than the threshold Sθ, that is, when the possibility that the unmanned vehicle 2 deviates from the target travel course CS is low, the unmanned vehicle 2 can travel at a high speed based on the travel condition generated by the management device 3. As a result, the decrease in productivity at the work site is suppressed.

In the present embodiment, the threshold Sθ is changed based on the target travel speed Vr. The threshold Sθ is set to a smaller value as the target travel speed Vr is higher. That is, even when the unmanned vehicle 2 turns a gentle curve, the travel condition is changed such that the travel speed Vs of the unmanned vehicle 2 becomes low when the target travel speed Vr is high. This prevents the unmanned vehicle 2 from deviating from the target travel course CS.

### Other Embodiments

In the above embodiment, the difference Δθ in the target azimuth θ between the adjacent travel points PI is calculated, and the change command is output based on the calculated difference Δθ. For example, a change command may be output based on a difference in the target azimuth θ among three or more travel points PI, and a change command may be output based on a difference in the target azimuth θ among a plurality of travel points PI which are not adjacent to each other (for example, every other travel point PI). That is, the travel condition change unit 13 may output the change command to change the travel condition specified by the travel condition data based on the difference in the target azimuth θ among the plurality of travel points PI.

In the above embodiment, the threshold Sθ is changed based on the target travel speed Vr. The threshold Sθ may be a variable value or a fixed value.

In the above embodiment, the unmanned vehicle 2 stops on the target travel course CS when it is determined that the difference Δθ is equal to or larger than the threshold Sθ. As described above, the unmanned vehicle 2 may travel at a speed lower than the target travel speed Vr when it is determined that the difference Δθ is equal to or larger than the threshold Sθ. Since the unmanned vehicle 2 travels at the speed lower than the target travel speed Vr, deviation from the target travel course CS is suppressed.

In the above embodiment, the travel condition change unit 13 compares the difference Δθ and the threshold Sθ. The travel condition change unit 13 does not necessarily compare the difference Δθ and the threshold Sθ. For example, the travel condition change unit 13 may lower the target travel speed Vr as the difference Δθ is larger, and may increase the target travel speed Vr as the difference Δθ is smaller.

Note that at least some of the functions of the control device 10 may be provided in the management device 3, and at least some of the functions of the management device 3 may be provided in the control device 10, in the above embodiment. For example, the management device 3 may have the function of the travel condition change unit 13 such that travel condition data that specifies a travel condition after being changed by the management device 3 based on a change command may be transmitted to the control device 10 of the unmanned vehicle 2 via the communication system 4, in the above embodiment. The travel control unit 14 of the control device 10 controls the traveling of the unmanned vehicle 2 based on the changed travel condition data.

### REFERENCE SIGNS LIST

1 MANAGEMENT SYSTEM

2 UNMANNED VEHICLE

3 MANAGEMENT DEVICE

4 COMMUNICATION SYSTEM

5 CONTROL FACILITY

6 WIRELESS COMMUNICATION DEVICE

7 LOADER

8 CRUSHER

10 CONTROL DEVICE

11 INTERFACE UNIT

12 TRAVEL CONDITION DATA ACQUISITION UNIT

13 TRAVEL CONDITION CHANGE UNIT

14 TRAVEL CONTROL UNIT

15 THRESHOLD STORAGE UNIT

16 THRESHOLD CHANGE UNIT

17 NOTIFICATION UNIT

21 VEHICLE MAIN BODY

22 DUMP BODY

23 TRAVELING DEVICE

23A DRIVE DEVICE

23B BRAKE DEVICE

23C STEERING DEVICE

24 SPEED SENSOR

25 AZIMUTH SENSOR

26 POSITION SENSOR

27 WHEEL

27F FRONT WHEEL

27R REAR WHEEL

28 WIRELESS COMMUNICATION DEVICE

31 TRAVEL CONDITION DATA GENERATION UNIT

32 INTERFACE UNIT

33 INPUT DEVICE

34 OUTPUT DEVICE

CS TARGET TRAVEL COURSE

HL TRAVEL PATH

IS INTERSECTION

PA WORK SITE

PA1 LOADING SITE

PA2 DISCHARGING SITE

PI TRAVEL POINT

1. An unmanned vehicle control system comprising:
a travel condition data acquisition unit that acquires travel condition data specifying a travel condition of an unmanned vehicle, the travel condition data including a target travel speed and a target azimuth of the unmanned vehicle at each of a plurality of travel points;
a travel condition change unit that outputs a change command to change the travel condition specified by the travel condition data based on a difference in the target azimuth among the plurality of travel points; and
a travel control unit that outputs a control command to control traveling of the unmanned vehicle based on the change command.

2. The unmanned vehicle control system according to claim 1, wherein
the travel condition change unit outputs the change command when the difference in the target azimuth is equal to or larger than a threshold, and
the travel control unit outputs the control command such that the unmanned vehicle travels based on the travel condition data when the difference in the target azimuth is smaller than the threshold.

3. The unmanned vehicle control system according to claim 2, further comprising
a threshold change unit that changes the threshold based on the target travel speed, wherein
the travel condition change unit outputs the change command based on the threshold determined by the threshold change unit.

4. The unmanned vehicle control system according to claim 3, wherein
the threshold change unit decreases the threshold as the target travel speed increases.

5. The unmanned vehicle control system according to claim 1, wherein
the change command includes lowering a travel speed of the unmanned vehicle below the target travel speed.

6. An unmanned vehicle comprising the unmanned vehicle control system according to claim 1.

7. An unmanned vehicle control method comprising:
acquiring travel condition data that specifies a travel condition of an unmanned vehicle, the travel condition data including a target travel speed and a target azimuth of the unmanned vehicle at each of a plurality of travel points;
outputting a change command to change the travel condition specified by the travel condition data based on a difference in the target azimuth among the plurality of travel points; and
outputting a control command to control traveling of the unmanned vehicle based on the change command.
